(19) United States
(12) Patent Application Publication
(10) Pub. No.: US 2014/0304178 A1
(43) Pub. Date: Oct. 9, 2014

(54) MOBILE APPLICATION FOR REAL ESTATE SHOPPING

(71) Applicant: Showing Suite, Inc., San Diego, CA (US)

(72) Inventors: Rick Robert Bengson, San Diego, CA (US); Seth Siegler, San Diego, CA (US)

(73) Assignee: Showing Suite, Inc., San Diego, CA (US)

(21) Appl. No.: 14/246,568

(22) Filed: Apr. 7, 2014

Related U.S. Application Data
(60) Provisional application No. 61/808,895, filed on Apr. 5, 2013.

(51) Int. Cl. G06Q 50/16; H04W 4/02

(52) U.S. Cl. CPC G06Q 50/16; H04W 4/02
USPC 705/313

(57) ABSTRACT

According to certain inventive techniques, a buyer's mobile device running an application is in communication with a server to facilitate communication regarding the showing of a listed real estate property. Using the application, the buyer can check into the showing. If a location of the buyer's mobile device then exceeds a predetermined distance from the property, a feedback request is automatically sent to the mobile device from the server.

### CROSS REFERENCE TO RELATED APPLICATIONS

This application claims priority to U.S. Pat. Appl. No. 61/808,895, filed on Apr. 5, 2013, the entirety of which is herein incorporated by reference.

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

Generally, this application relates to an application (or app) for one or more mobile devices that works in connection with a server. The application allows the user to take notes with respect to real estate properties and otherwise enter and store information. The application also facilitates communication between buyer, seller, and/or other collaborators.

As used herein, the term “buyer” may encompass one or more parties, including the (potential) buyer, the buyer's agent (for example, a showing agent), and/or any other party authorized to act on behalf of the buyer. As used herein, the term “seller” may encompass one or more parties, including the (potential) seller, multiple sellers, one or more tenants, the seller's agent (for example, a listing agent), and/or any other party authorized to act on behalf of the seller.

### SUMMARY

According to certain inventive techniques, a method for facilitating communication regarding a listed property using a mobile device running an application, wherein the mobile device is in communication with at least one server, includes the steps of: determining a first location of the mobile device; receiving, by the application from the mobile device, a signal indicative of a request by a user of the mobile device to check in to a showing of the listed property; if a comparison of the first location of the mobile device and the location of the listed property satisfies a first condition, presenting an option for the user to check in to the showing of the listed property via the mobile device; receiving, by the application from the mobile device, a signal indicative of an affirmation by the user to check in to the showing of the listed property; in response to receiving the signal indicative of an affirmation by the user to check in to the showing of the listed property, checking the user in to the showing of the listed property; after checking the user in to the showing of the listed property, determining a second location of the mobile device; if a comparison of the second location of the mobile device and the location of the listed property satisfies a second condition, automatically providing a feedback request to the mobile device.

According to one technique, the method further includes the step of: if the comparison of the second location of the mobile device and the location of the listed property satisfies the second condition, automatically checking the user out of the showing of the listed property. According to one technique, the method further includes the step of: sending a communication to the mobile device indicating that the showing of the listed property has ended. According to one technique, the first condition is satisfied when the first location of the mobile phone and the location of the listed property are in the same zip code. The second condition may be satisfied when a distance between the second location of the mobile device and the location of the listed property is greater than a predetermined distance. According to one technique, the feedback request comprises a push notification on the mobile device.

According to certain inventive techniques, a method for facilitating communication regarding a listed property using a server, wherein the server is in communication with at least one mobile device, includes the steps of: receiving a communication from the mobile device including a first location of a mobile device; comparing the first location of the mobile device with a location of a property to determine if a first condition is satisfied; if the first condition is satisfied, sending a communication to the mobile device including an indication the property is available for showing; receiving a communication from the mobile device including a request to check in to a showing of the property; subsequent to said receiving a communication from the mobile device including a request to check in to a showing of the property, receiving a communication from the mobile device including a second location of a mobile device; comparing the second location of the mobile device with the location of a property to determine if a second condition is satisfied; if the second condition is satisfied, sending a communication to the mobile device including a feedback request.

According to one technique, the method further includes sending a communication to the mobile device indicating checking out of the showing when the comparison of the second location of the mobile device and the location of the listed property satisfies the second condition. According to one technique, the first condition is satisfied when the first location of the mobile phone and the location of the listed property are in the same zip code. According to one technique, the second condition is satisfied when a distance between the second location of the mobile device and the location of the listed property is greater than a predetermined distance. According to one technique, the second condition is satisfied when a distance between the second location of the mobile device and the location of the listed property is greater than a predetermined distance. According to one technique, the feedback request comprises a push notification.

### BRIEF DESCRIPTION OF SEVERAL VIEWS OF THE DRAWINGS

FIGS. 1-38 and 41 illustrate screen shots of a buyer's mobile device running an application, according to certain inventive techniques.

FIGS. 39, 40, and 42 illustrate screen shots of a seller's mobile device running an application, according to certain inventive techniques.

FIG. 43 illustrates a system for communicating regarding a showing of a property, according to certain inventive techniques.

FIG. 44 illustrates a method for communicating regarding a showing of a property, according to certain inventive techniques.

FIG. 45 illustrates a method for communicating regarding a showing of a property, according to certain inventive techniques.

FIG. 46 illustrates a method for communicating regarding a showing of a property, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

One or more mobile applications may enable home shoppers (buyers) to take text notes, pictures and videos during home showings. Users may elect to collaborate and share notes, pictures and videos with select other users. Select images, videos and text notes may be selectively shared on social networks, sent by email, or sent via SMS.

A home shopper can use a “check in” feature in the application to geolocate his or her position at a house for sale. In response to the geolocation, a server may be queried to gather specific details about the house, including price, interior and exterior pictures, and other details.

Home shoppers can elect to receive status change notifications each time a previously checked-in listing changes to “sale pending,” “sold,” “back on market,” “price change,” etc.

Real estate agents that may accompany buyers to showings (showing agents, and also within the scope of the term “buyer” as used herein) may get agent-specific features when they sign into the applications. In addition to being able to collaborate with his or her buyers on notes, pictures and videos, he or she may also check in to showings. This may trigger a notification to the home seller alerting him or her that the showing has begun. When the buyer is ready to leave the showing, he or she can check out in the app, which will trigger another notification to the seller alerting them that the showing has ended, and if the showing agent does not use the app to check out, the application will automatically check out once the showing agent exits a pre-defined radius from the property. (The application may use GPS to detect the exit from the pre-defined radius.) The “end of showing” notification may be sent to the seller automatically in the event of this type of check out.

After the buyer checks out of showing (either manually or by exiting the pre-defined radius from the house) a showing feedback request may be sent to him or her via a push notification. The buyer may accept the feedback request and may be taken to a feedback questionnaire. The responses can be sent to the home seller, the seller's real estate agent or both.

A mobile app user receives a push notification to fill out a survey that was automatically triggered by an event. He or she navigates through that notification to fill out the survey. For example, any mobile app user can be sent a survey as a notification. As another example, any time a property is shown and it is triggered by a lockbox, GPS location, or Check In on the app, then the app receives a push notification to fill out the survey in the app or on a web page.

An SMS may be sent when a user clicks a link on a mobile app when they are in a geo-specific location. It also can send an SMS when they move from that location by a pre-determined amount of space (e.g. 1000 ft.). As an example, an SMS may be sent when a user clicks a link on a mobile app when they are in a geo-specific location, and it sends info specific about that location to the recipient. It also can send an SMS when they move from that location by a pre-determined amount of space (for example, 1000 feet).

Users can determine to share notes in mobile apps with one another. A mobile app user may share a particular note or all notes by another invited user private to just those invited users. For example, such notes may correspond to a particular property or all properties that a user views in the app including how he or she ranked it from being the most favorite to least favorite property.

Using the geo check in feature, a link in a mobile app may be selected which causes real estate data associated with that particular property to be pulled into the application, and then use the productivity tools that are specific to that one property. A user may receive email and push mobile notifications for homes that they have selected and GEO checked into.

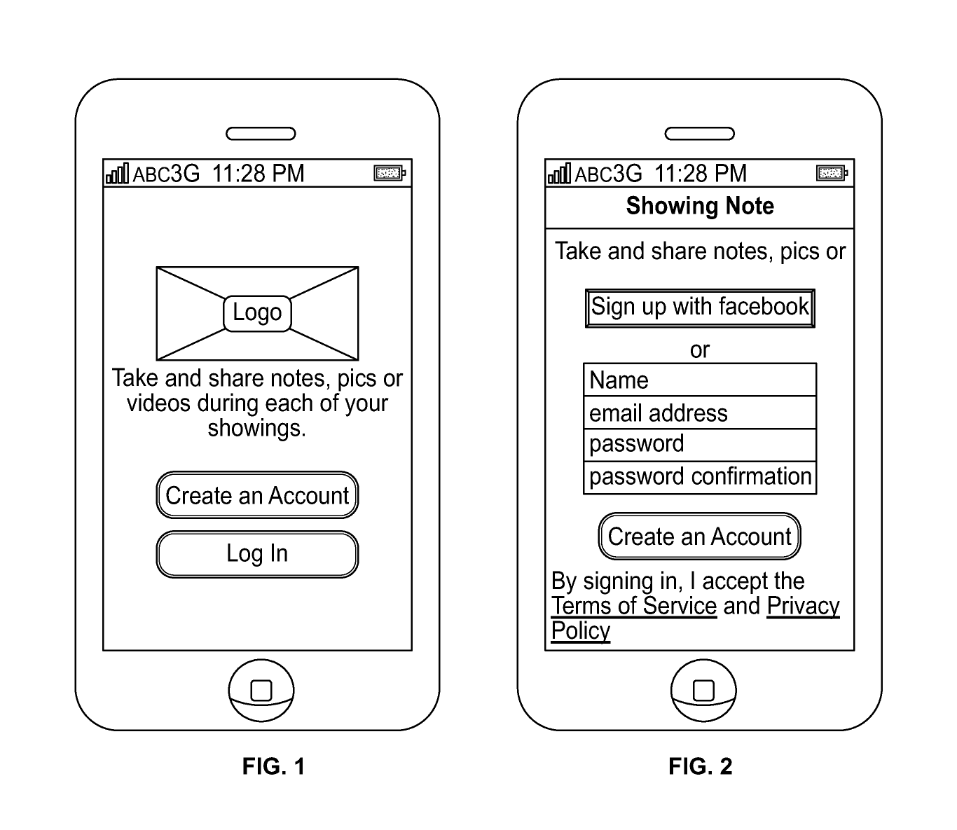

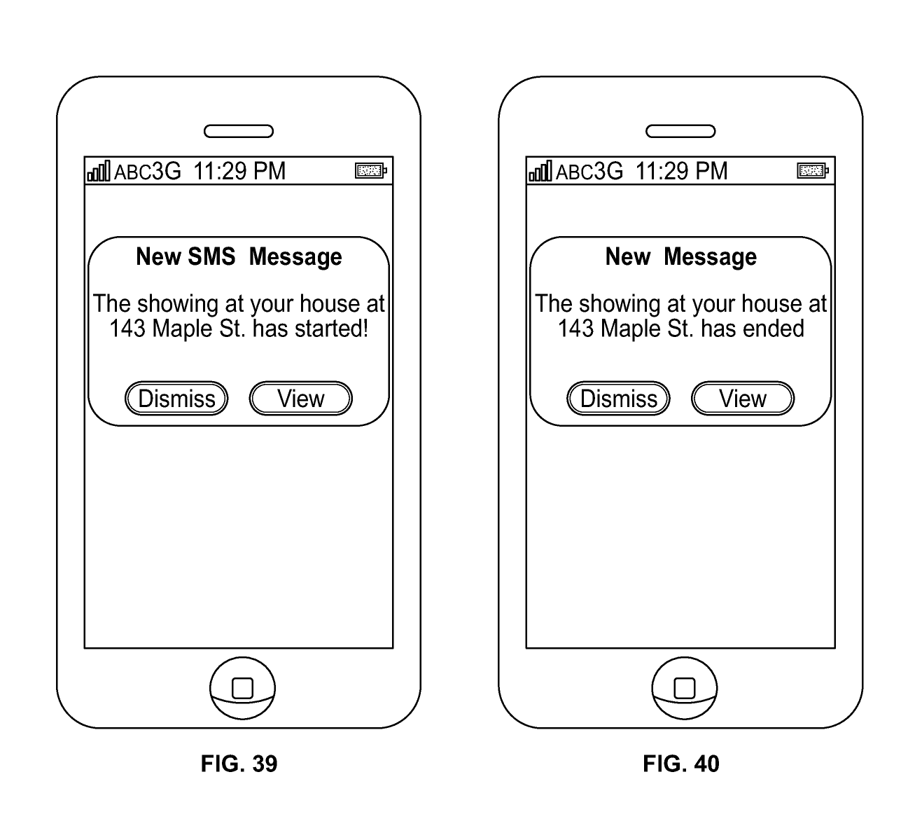

FIGS. 1-38 and 41 illustrate screen shots of a property buyer's mobile device running an application, according to certain inventive techniques. This application is termed the buyer's application. FIGS. 39, 40, and 42 illustrate screen shots of a property seller's mobile device running an application, according to certain inventive techniques. This application is termed the seller's application.

A mobile device may include a mobile phone, tablet, laptop, or other device that allows for wireless networking. An application can be one application, or more than one applications working together to achieve the inventive techniques discussed herein.

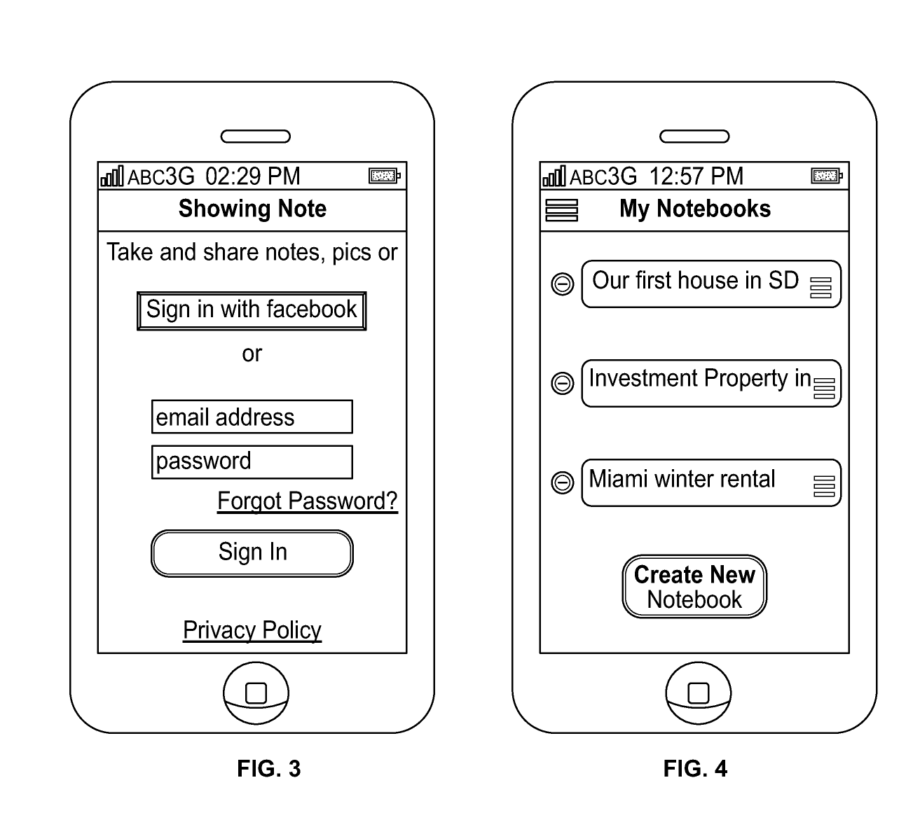

The buyer's application may require a log in and, if so and the buyer is not already logged in, the display shown in FIG. 1 may appear. The display depicted in FIG. 1 may include a logo and options to either create an account or log in to an existing account. If the buyer selects “Create an Account,” then the display transitions to that illustrated in FIG. 2. If the buyer selects “Log In,” then the display transitions to FIG. 3.

At FIG. 2, the buyer may sign in with Facebook® or may enter in personal credentials and a password from scratch. When selecting to sign up with Facebook®, the application may import the buyer's name and email. After signing up, the display transitions to FIG. 4.

At FIG. 3, the buyer may sign in using Facebook® or with an email/password. If successful, the display will transition to FIG. 4 after the user has signed in.

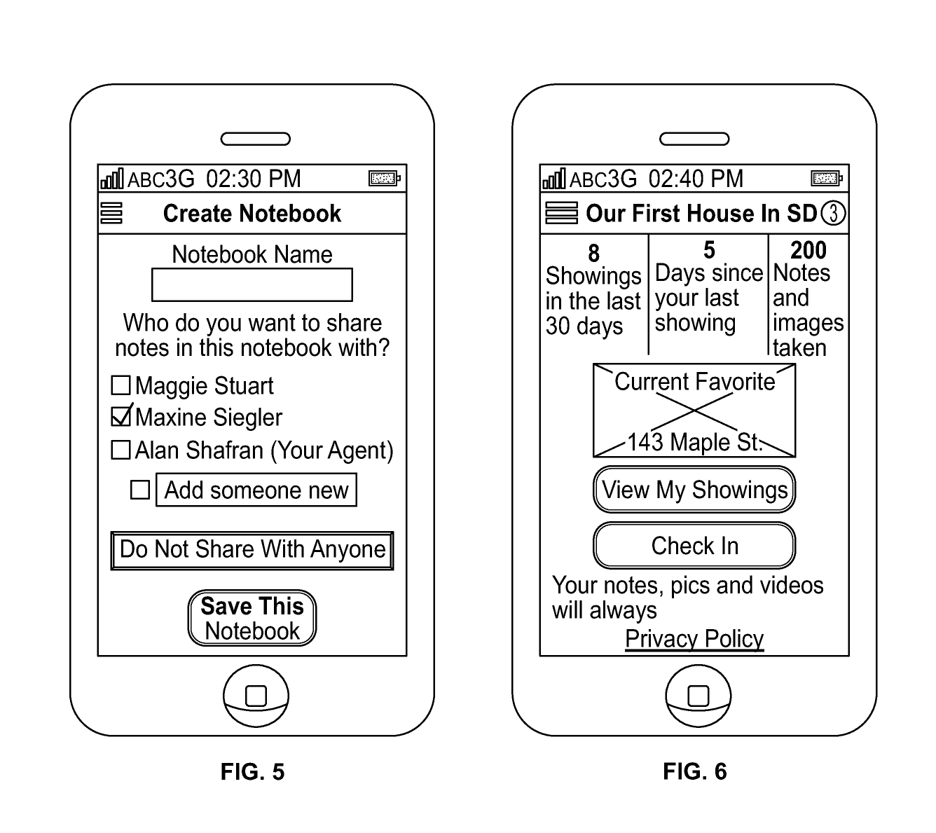

At FIG. 4, three different “notebook” titles are displayed. A notebook may include information about one or more listed properties. When a property has been showed to the buyer, the property may be referred to as a “showing.” The buyer may sort notebooks by dragging and dropping the titles. The buyer may also delete notebooks by selecting an icon such as the “minus” sign to the left of a given notebook title. The buyer can select one of the notebook titles to display the given notebook, or the buyer may create a new notebook. If a notebook is selected, then the display transitions to FIG. 6. If a notebook is to be created, then the display transitions to FIG. 5.

At FIG. 5, the buyer can create a notebook. The notebook name can be entered. The buyer has the option to share information associated with the notebook with one or more of the buyer's contacts. When information is shared, the contact may be a user of a similar application running on another mobile device. Information may be shared automatically through the similar application and/or a push notification may be provided on the contact's mobile device. As discussed below in more detail, select images, videos and text notes may be selectively shared on social networks, sent by email, or sent via SMS. The buyer may also have the option to add a new contact. The buyer may also select “Do Not Share With Anyone” to uncheck all of the contacts. The buyer can save the notebook. After saving the notebook, the display transitions to FIG. 6.

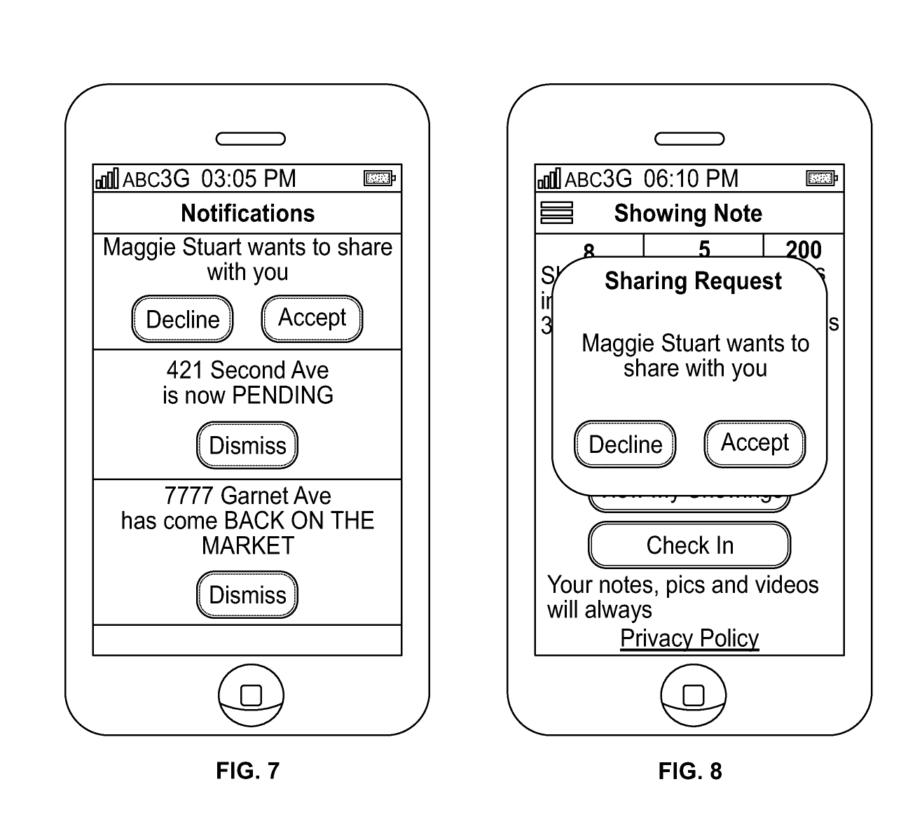

FIG. 6 shows a “dashboard,” which is a landing screen after the user selects a notebook or creates a new notebook. The dashboard lists the title of the selected or newly created notebook (“Our First House in SD”) and a number of notifications pending (“3”). The buyer may select the icon showing the number of notifications pending, and the display may transition to FIG. 7.

The dashboard shows the number of showings of properties in the notebook (for example, 8 showings in the last 30 days), the number of days since the last showing of a property in the notebook, or the number of notes and images taken associated with the properties in the notebook.

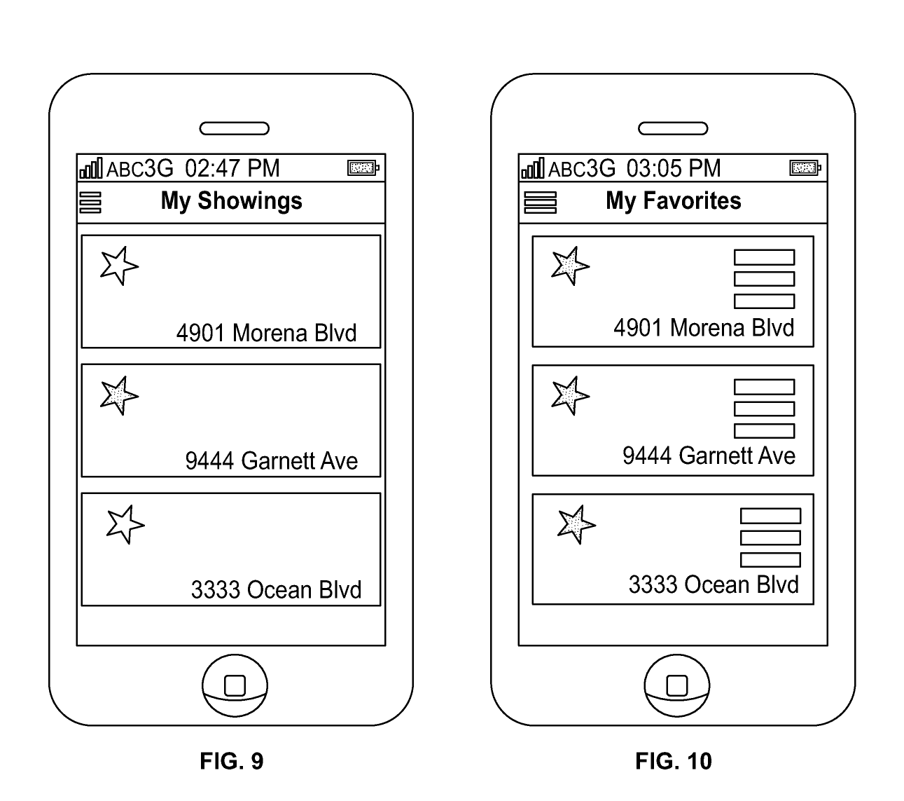

The buyer can select the number of showings of properties in the notebook by selecting a portion of the screen in the general area of that language. The display will then transition to a display such as that shown in FIG. 9. The properties listed in the transitioned-to display may include all of the shown properties, or only the ones shown in a specified period of time (for example, the last 30 days).

The buyer can select the “days since your last showing” by selecting a portion of the screen in the general area of that language. The display will then transition to a display such as that shown in FIG. 12. The property listed in the transitioned-to display may be the most recently shown property.

The buyer can select the “Notes and images taken” by selecting a portion of the screen in the general area of that language. The display will then transition to a display that lists indications all of the text notes or images or videos (or more simply “notes” hereinafter) associated with that notebook. The notes may be sortable or otherwise grouped according to one or more of the following criteria: items entered by the buyer; shared items; videos; images; or text notes. When listed, selecting a given note indication may cause the substance of the note to appear.

The dashboard also shows the “Current Favorite Listing” which shows a picture of the buyer's chosen favorite property. There may be more than one “favorite” property, in which case only the #1 favorite may be shown. An identifying characteristic of the favorite property may be shown, such as the address of the favorite property over the picture. Selecting the “Current Favorite Listing” may cause the display to transition to a display such as that shown in FIG. 12, at which details of the favorite property are displayed. If there are multiple favorites, the display may transition to FIG. 10. The dashboard also allows the buyer to “View My Showings” and the display will transition to FIG. 9. The dashboard also allows the user to “Check In” and the display transitions to FIG. 28.

FIG. 7 shows the pending notifications. When another user wishes to set up two-way sharing, the buyer may receive a notification to accept or decline the connection. Other types of notifications include when a property is sold, price change, sale pending, or similar types of statuses. The buyer may delete the notification by selecting “dismiss.”

FIG. 8 shows a pop-up option for initiating sharing of notes between the buyer and another user. When the other user adds the buyer to collaborate with, the popup may appear (superimposed on any display of the application, for example) offering the buyer to accept or decline the invitation to share. Other types of notifications are possible, such as email or SMS notifications.

FIG. 9 shows a listing of properties (for example, the shown properties). Each item in the list may include an option to select/deselect that property as a favorite (for example, a star or heart icon that changes colors), an address, and an image. Touching on the image or other parts of the item may cause the display to transition to a detail page for that property, such as the view shown at FIG. 12. The buyer may scroll down or up on the screen to view properties not immediately displayed. Items may be dragged and dropped to sort the list.

FIG. 10 shows a listing of properties (for example, favorite properties). Each item in the list may include an option to select/deselect that property as a favorite (for example, a star or heart icon that changes colors), an address, and an image. Touching on the image or other parts of the item may cause the display to transition to a detail page for that property, such as the view shown at FIG. 12. The buyer may scroll down or up on the screen to view properties not immediately displayed. Items may be dragged and dropped to sort the list. For example, the item at the top of the list may be the #1 favorite property.

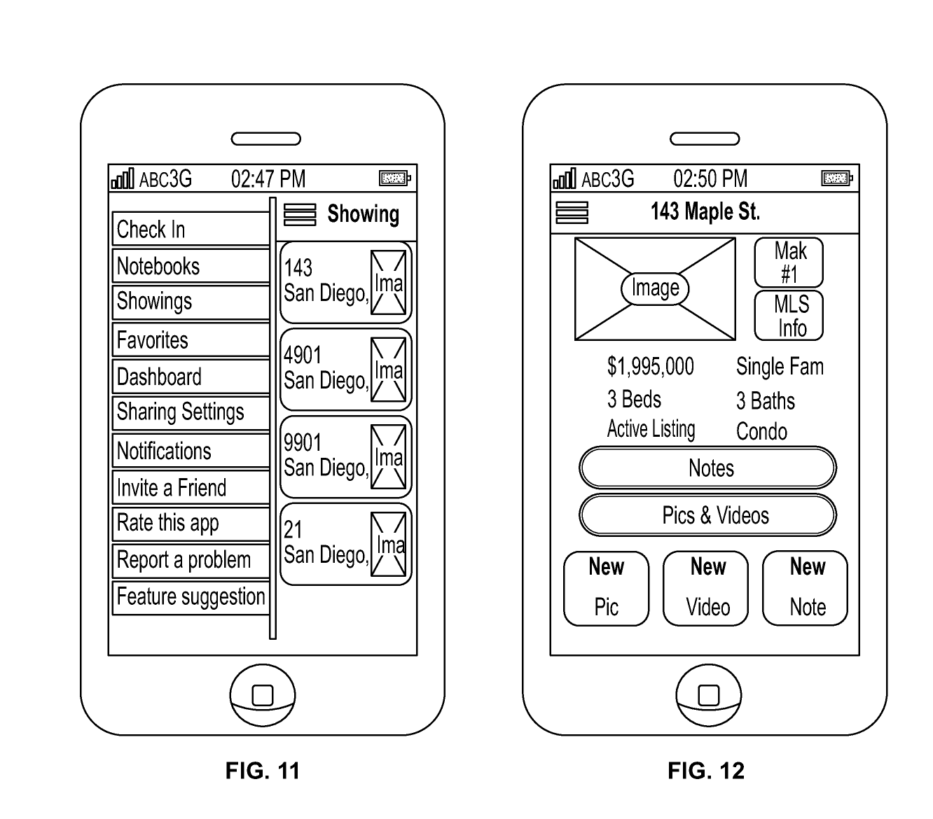

FIG. 11 is a display of the main menu landing page. This display may be accessed by selecting a menu icon on another page (not shown). On the left side, a number of options are provided. The buyer can check in (causing transition of the display to FIG. 28), open notebooks (causing transition of the display to FIG. 4), go to showings (causing transition of the display to FIG. 28), view favorite properties (causing transition of the display to FIG. 10), view the dashboard (causing transition of the display to FIG. 6), or adjust sharing settings (causing transition of the display to FIG. 36). The buyer may also select notifications to adjust notification settings, invite a friend (which may open up a native email editor with a pre-populated email that the user can send to a friend (that may include a link to download the application)), rate this app to go to an app store rating display, report a problem (which may open the native email editor with an administrative email address pre-populated), and feature suggestion (which may open the native email editor with an administrative email address pre-populated). On the right side, the different properties may be shown in a list view and may have functionality similar to FIG. 9. In one example, selecting anywhere in this area may cause the display to transition to FIG. 9.

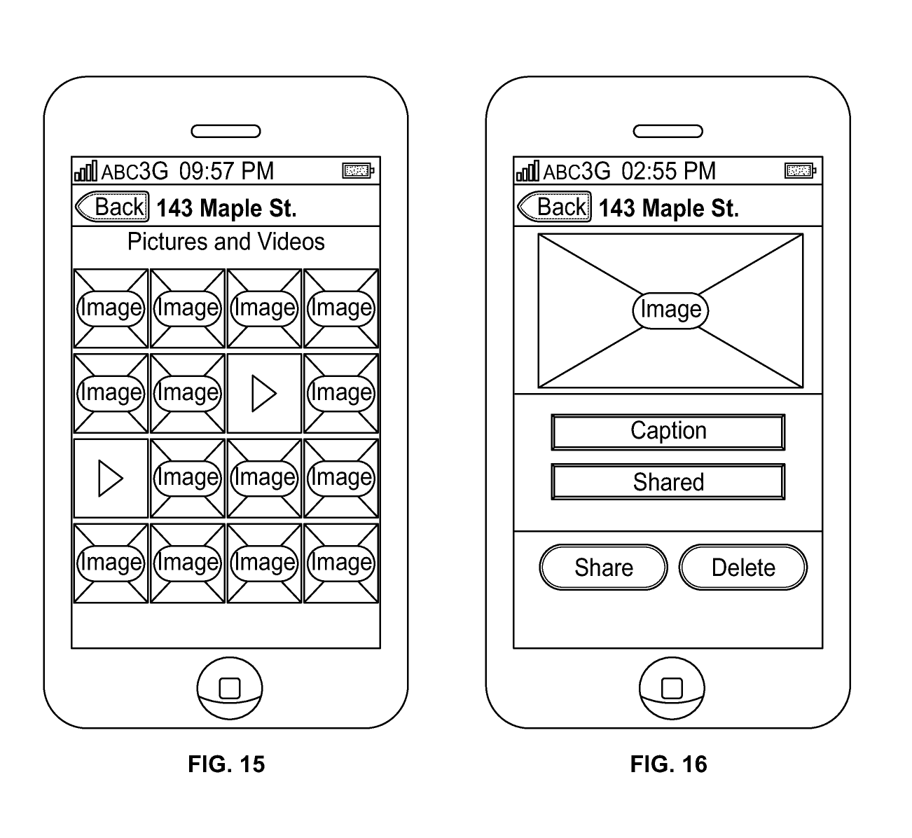

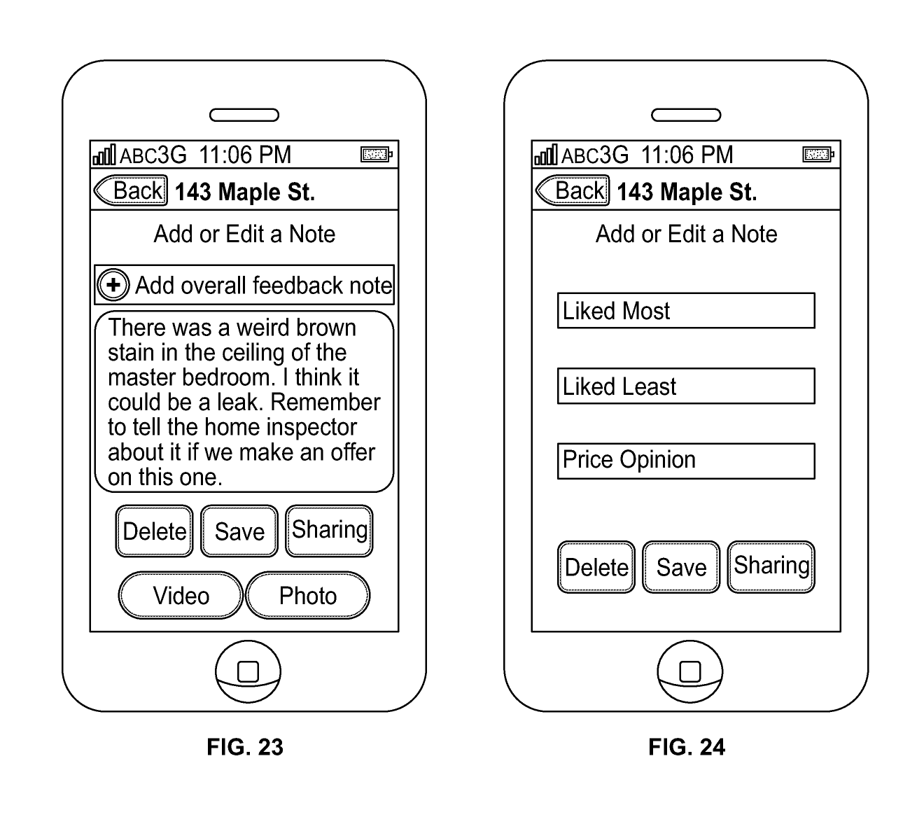

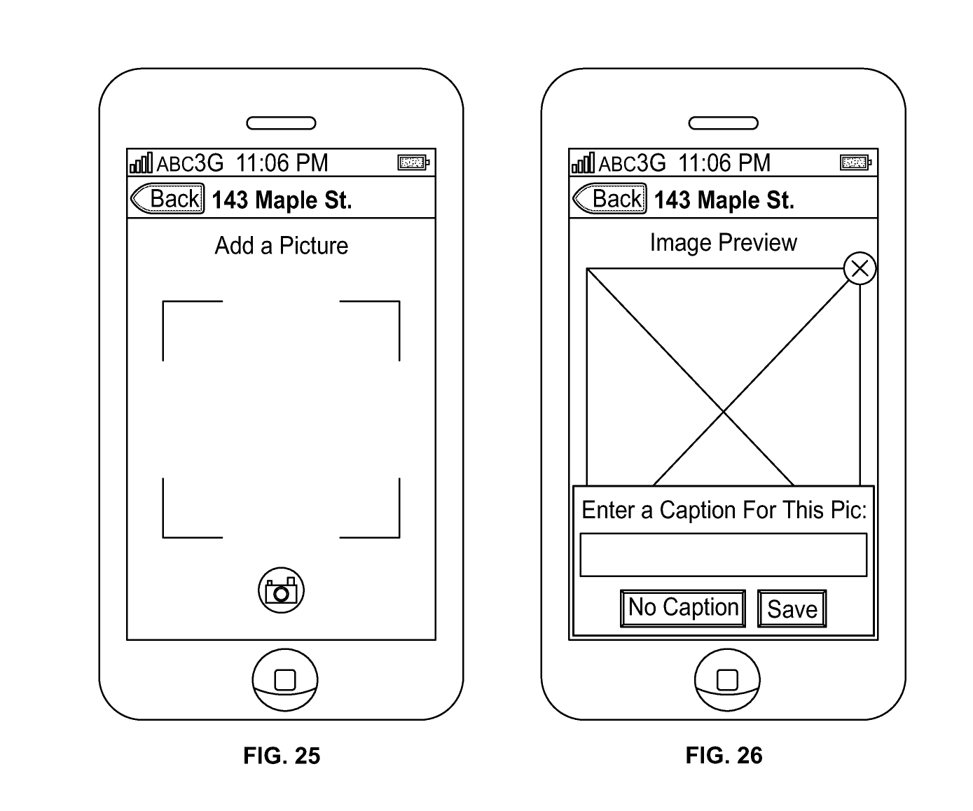

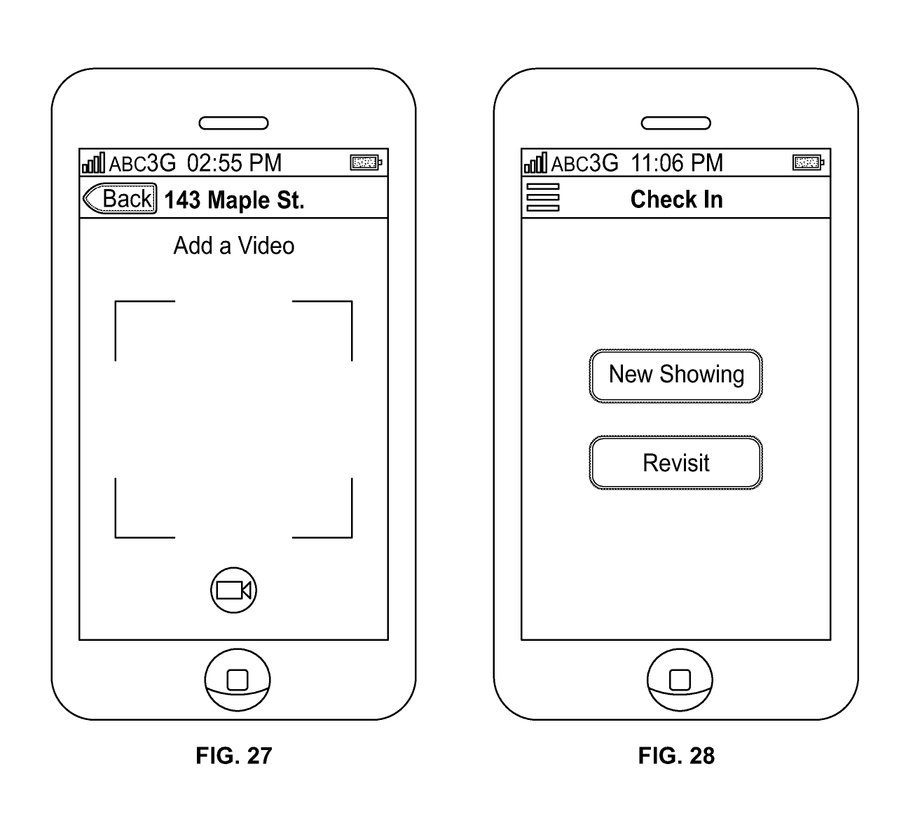

FIG. 12 is a display of a property's details. The details may show the property's address. The details may include an image (the buyer can scroll through images in this area) or MLS data (for example, price, type of dwelling, number of beds, number of baths, status of listing, or the like). The details may provide an option to view more MLS data (which may cause the display to transition to FIG. 14). The details may also provide an option to make the property a favorite, or to make it the #1 favorite. Selecting such an option may cause the display to transition to FIG. 9. An option to view notes may be provided (which may cause the display to transition to FIG. 22). An option to view pictures or videos may be provided (which may cause the display to transition to FIG. 15). An option to add a note may be provided (which may cause the display to transition to FIG. 23). An option to add a picture may be provided (which may cause the display to transition to FIG. 25). An option to add a video may be provided (which may cause the display to transition to FIG. 27).

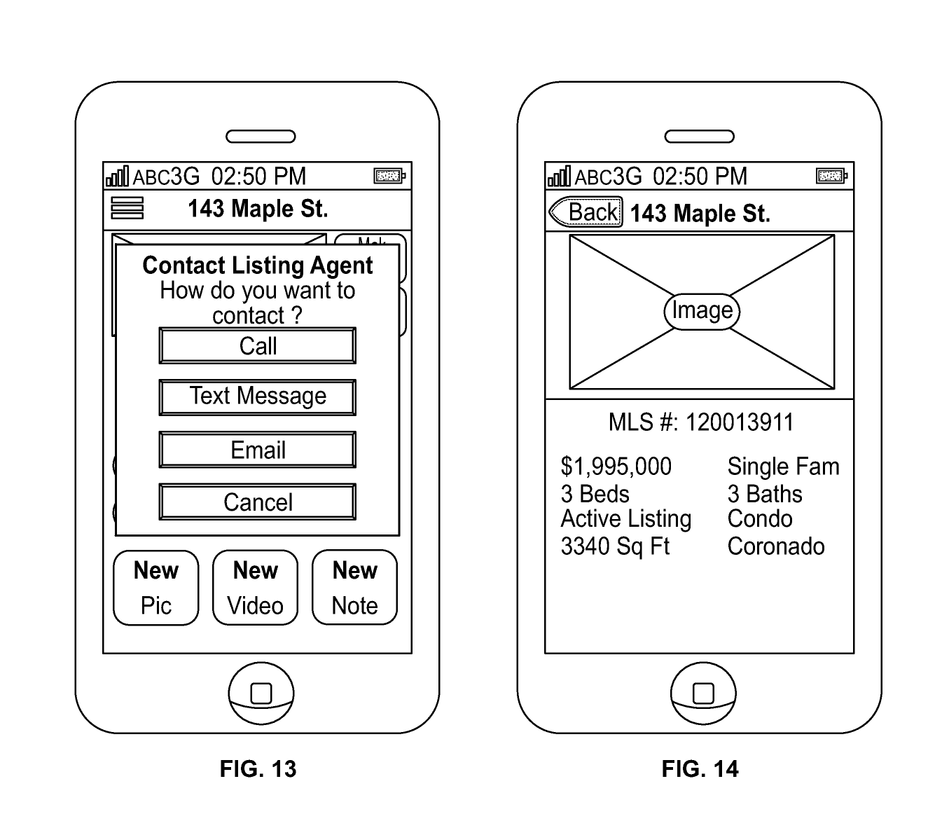

FIG. 13 shows a display similar to FIG. 12 that may be offered in some versions of the application (for example, a free version of the application). This display may include an option to contact a listing agent through a phone call. Selecting the “call” area may bring the buyer to a native phone app with the listing agent's phone numbers prepopulated (for example, from MLS data). Selecting the “text message” area may bring the buyer to a native SMS app with the listing agent's phone number prepopulated or a predetermined message (for example, “I'm interested in learning more about [property address]”). Selecting the “email” area may bring the buyer to a native email app with the listing agent's email address prepopulated. The subject line may also be prepopulated (for example, with the property's address) and a message may also be prepopulated (for example, “I'm interested in learning more about [property address].”)

FIG. 14 shows extended MLS data for a given property. Such extended data may include the following: MLS number, lot size, square footage, dwelling style, city, area, lot description, garage status/size, parking status, dwelling material, zip code, description, or listing agent. Other MLS data may also appear. If all of the data does not fit on one screen display, the buyer can scroll down to see more. A “back” button may also be provided to return the buyer to the previous screen. One or more of all of the screens may also have a “back” button or a “forward” button to advance or retreat through previous chronological page views.

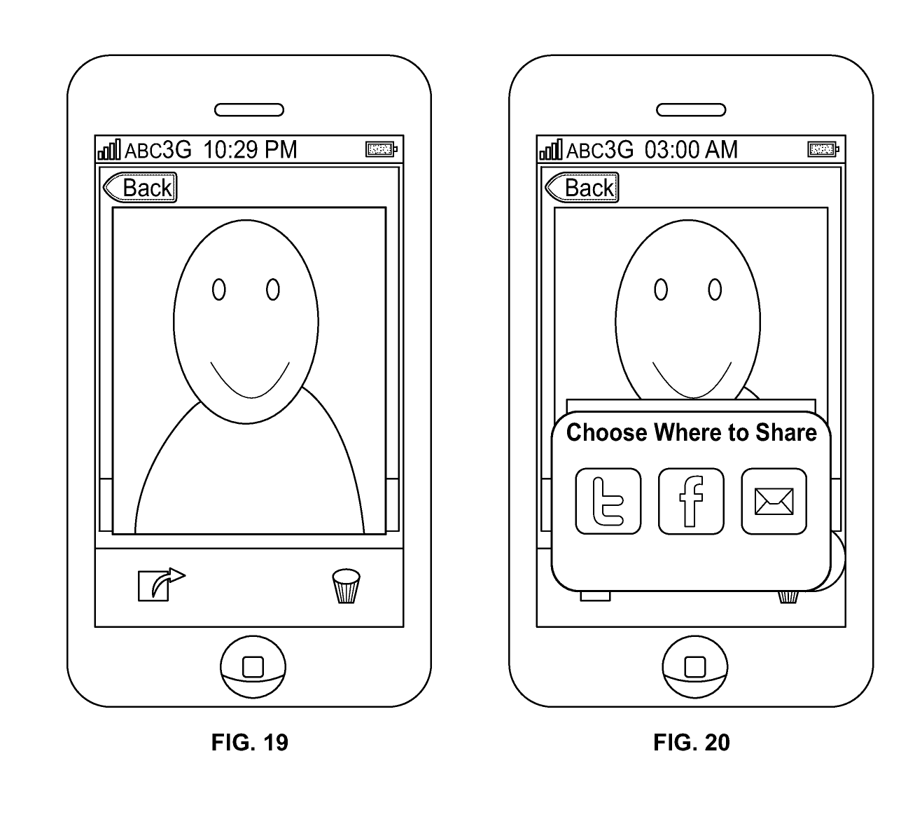

FIG. 15 is a display of pictures and videos of a given property (which may be identified on the display by address). The display may show thumbnails of the pictures/videos. Selecting a thumbnail for a picture may transition the display to FIG. 16. Selecting a thumbnail for a video may transition the display to FIG. 19.

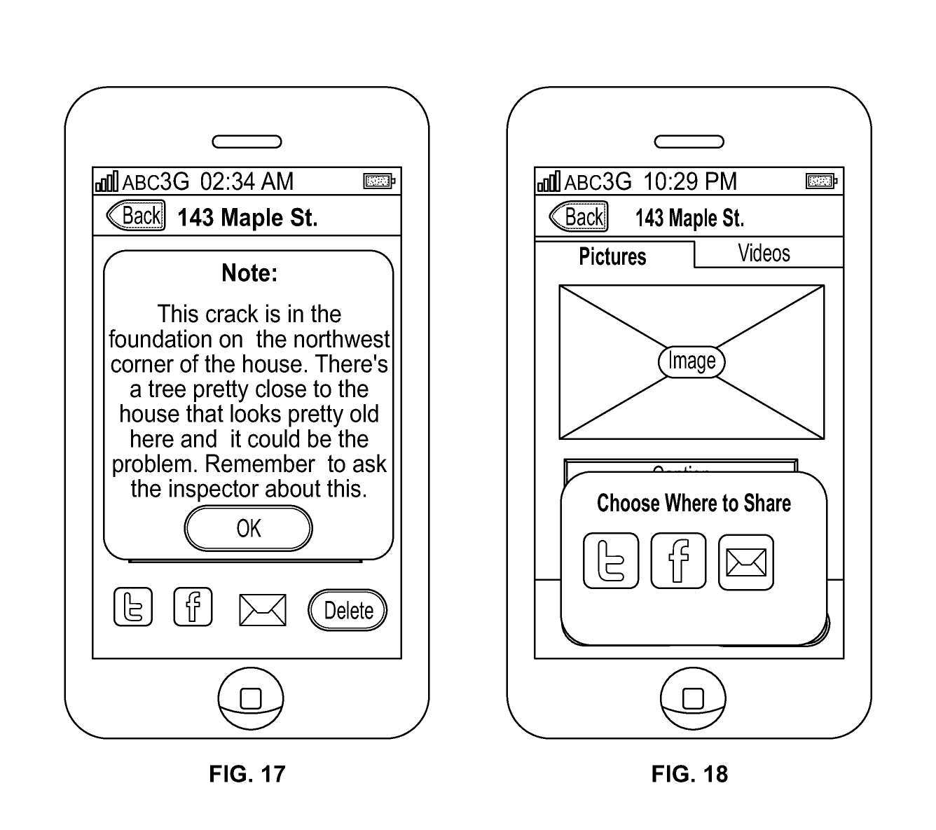

FIG. 16 is a detailed display of a picture of a given property (which may be identified on the display by address). The picture may appear as well as a caption (if present). The buyer may view other images sequentially by swiping or selecting an arrow icon (not shown). The images may include user-taken images and MLS source images. The buyer may select the caption and the display may transition to FIG. 17. A “shared” indication lets the buyer know that the image has been shared with collaborators. The buyer can select the “shared” indication and it will toggle to “not shared,” thereby causing the image to not be shared with collaborators. Toggling back to “shared” is also possible through selection of the “not shared” indication. A “share” indicator allows the buyer to share the image and may transition the display to FIG. 18.

FIG. 17 is a display of a caption of a picture displayed in FIG. 16. Selecting the “OK” indicator or the “Back” indicator may cause the display to transition back to FIG. 16. FIG. 18 provides indicators that enable the buyer to share the picture (from FIG. 16) through Twitter®, Facebook®, or email. When selecting for email sharing, the native email editor may be displayed and the image may be automatically embedded in the image. After sharing, the display may transition back to FIG. 16.

FIG. 19 shows a video player that can play a selected video from FIG. 15. The display may employ a native video player. Selecting the “back” indicator may transition the display to FIG. 15. The buyer may share the video by selecting the sharing indicator, which may transition the display to FIG. 20.

FIG. 20 provides indicators that enable the buyer to share the video (from FIG. 19) through Twitter®, Facebook®, or email. When selecting for email sharing, the native email editor may be displayed and the video may be automatically embedded in the image. After sharing, the display may transition back to FIG. 19.

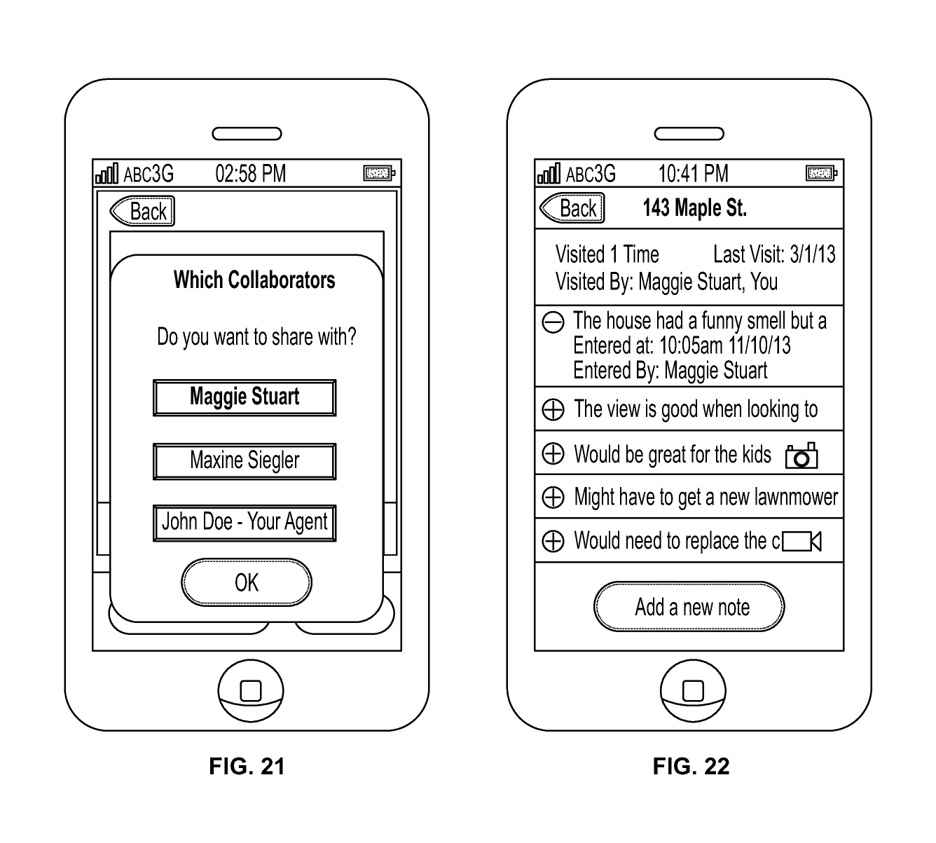

FIG. 21 shows a display that allows the buyer to choose which collaborators to share with. Such options may be available any time the buyer chooses to share information during operation of the application, and may appear as an intermediate display.

FIG. 22 shows a display that lists notes associated with a given property. The notes may be sortable by one or more different parameters such as user-entered notes, shared notes, time of note, or type of note (text/picture/video). The notes may be expandable/collapsible to view/hide more details such as date entered and author, more text, or one or more pictures/videos. When collapsed, the note may display only a caption. The notes may include a picture/video icon identifying that a picture/video is included in the note. Selecting the picture/video may cause the picture/video to be displayed. An option may be provided to add a new note, and the display may transition to FIG. 23.

FIG. 23 shows a display that allows the buyer to enter a new note. The display may provide areas to enter a caption (not shown) and body of a note. The display may provide the ability to add an “overall feedback note,” the selection of which may cause the display to transition to FIG. 24. The display has options to delete or save the note. The display also has selectable icons that allow the buyer to add a video (transition to display in FIG. 27) or photo (transition to display in FIG. 25) to the note. The buyer may also select to share the note with collaborators. The “sharing” icon may change to say “unshare” to allow the buyer to toggle between sharing/not sharing the note.

FIG. 24 shows a display that shows an “overall feedback note.” This note provides options to select whether the property is liked most, liked least, or the opinion of the price. Like other notes, it can be deleted, saved, shared, or unshared.

FIG. 25 shows a display that facilitates a user to take a picture for a note. After taking a picture, the view may freeze for a moment to allow for review and entry of a caption by transitioning the display to FIG. 26. FIG. 26 shows a display that allows the buyer to enter a caption for the picture, no caption for the picture, and to save the picture. After captioning the picture, the display may transition back to FIG. 25 so more pictures can be taken. FIG. 27 shows a display that facilitates a user to take a video for a note.

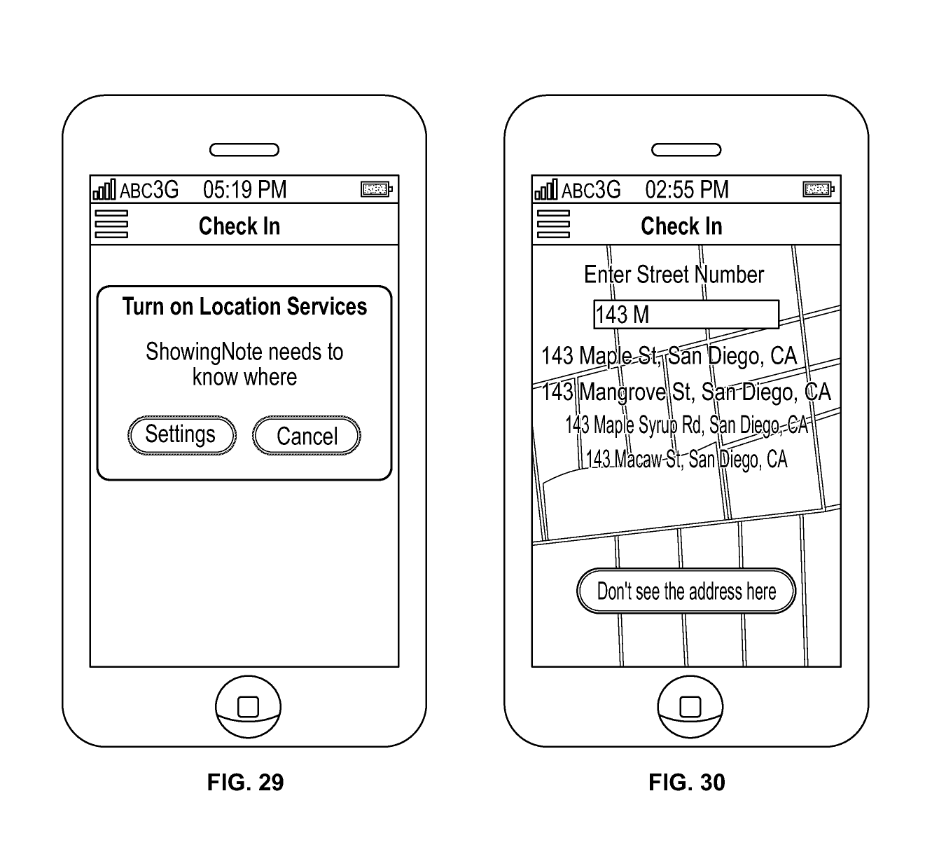

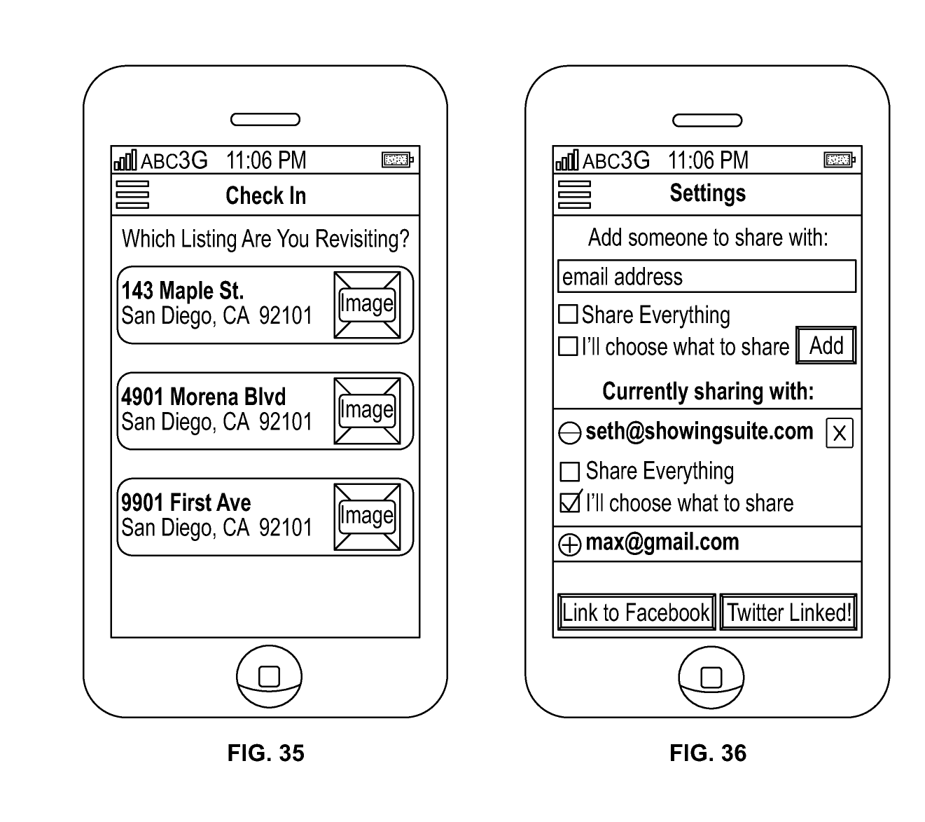

FIG. 28 shows a display that allows a user to check in to a showing of a listed property. The user may select a new showing. If the user selects the new showing, the application may first check to see if location services (for example, geolocating services to geolocate the mobile device, such as GPS) are turned on in the device or application. If the location services are not turned on, the display may transition to FIG. 29. If location services are on, the display may transition to FIG. 30. The user may also select to revisit a property. Such a selection may cause the display to transition to FIG. 35.

FIG. 29 shows a display that allows the user to turn on or keep location settings off. The “settings” button may cause the settings application to be displayed so that the user can enable location services. Optionally, the showing application may automatically turn on/off location services without transitioning the display to the settings application. After selection of the chosen mode, the display may transition to FIG. 30.

After location services are on, the application may geolocate the mobile device, for example, by obtaining latitude/longitude coordinates from the GPS module in the mobile device. From these coordinates, a determination may be made (either by the mobile device or by the server) what zip code the mobile device is in. The mobile device may then identify all or some of the listings in that zip code, for example, by receiving the listings from the server (which may provide appropriately matched listings from a database such as the MLS database).

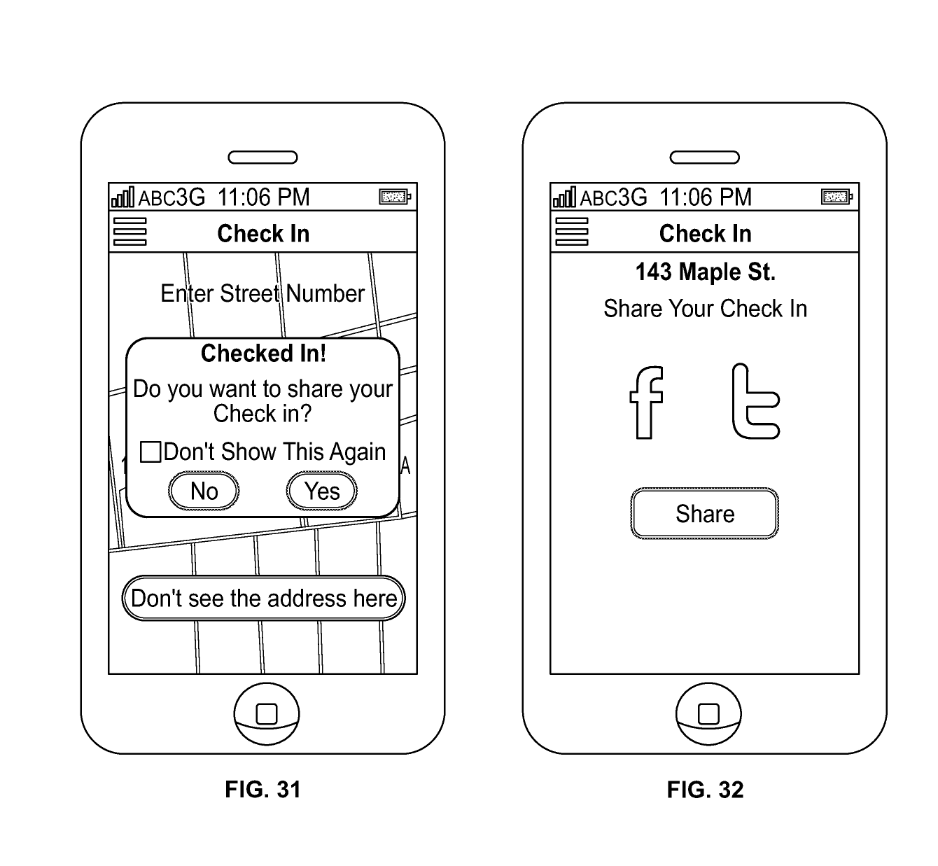

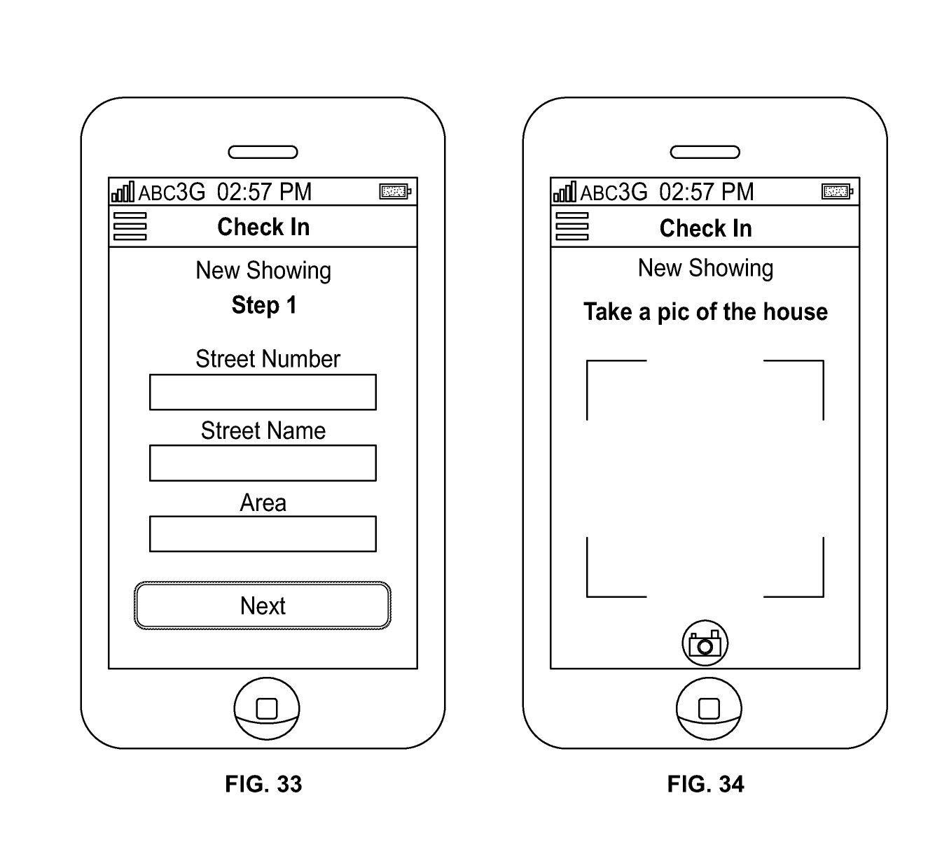

FIG. 30 shows a display that allows the user to begin entering the address of the property to be shown, and a list of property addresses may responsively autopopulate. The user can select the appropriate address and the display may transition to FIG. 31. Selecting the address may cause the user to be checked in to the showing of that property. Otherwise, the user may select “don't see the address here,” and the display may transition to FIG. 33.

FIG. 31 shows a display that indicates that the user has checked in to the showing of the property. The user can choose to share that he or she has checked in. If the user chooses not to share check-in data, then the display may transition to FIG. 12. If the user chooses to share check-in data, then the display may transition to FIG. 32. FIG. 32 shows a display that allows a user to share check-in data through social media such as Facebook® or Twitter®. By selecting the “share” indicator, the display may transition to FIG. 12. Checking in may also notify another mobile device (for example, the seller's mobile device) that a showing has started (see FIG. 39). Such notification may be in the form of SMS, automated phone call, and/or email.

FIG. 33 shows a display that allows the user to add a property to check in to that is not listed on the database (for example, the MLS database). The user can enter the property address and information about the “area.” By selecting “next” the display may transition to FIG. 34. FIG. 34 shows a display that allows the user to take a picture of the house. This may be the second step of adding a listing to the database when it is not available through the MLS data source feed. After taking the picture, the display may transition to FIG. 12.

FIG. 35 shows a display that allows the user to check in to a property that is being revisited. The display may list the properties previously shown. The user may select one of these properties, and the display may transition to FIG. 12.

FIG. 36 shows a display that allows the user to adjust sharing settings of the application. The user can type in an email address of a collaborator to share with. Specific permissions can be provided for each collaborator (for example, share everything or selectively share information). Collaborator information and/or permissions may be viewed/hidden with toggling expand/collapse icons. The user may also use this display to link to social media sites such as Facebook® or Twitter®. Pressing the appropriate “link” indicators may authorize the real estate showing application to post on the given social media site.

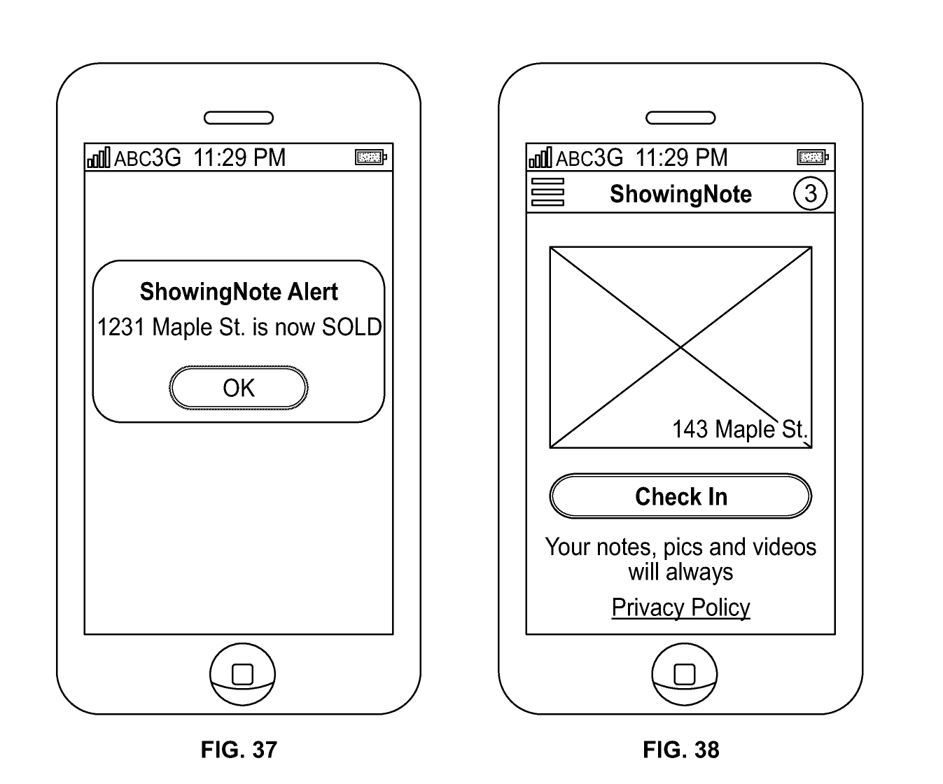

FIG. 37 shows a display that automatically alerts the user to a change in status of a property. Such statuses may include: sold; pending; under contract; price change; or back on market. This information may be pushed from the server to the mobile device based on changes in the database (for example MLS database). Such information may be pushed even if the mobile application is not running (for example, through native push notifications on the mobile device). According to one technique, the user must have previously checked in to the listing to trigger status alerts in the future. Notifications may also be made through SMS, automated phone call, email, and/or social media sites.

FIG. 40 shows a display on a seller's mobile application that indicates a showing has ended. Additionally, a notification may be sent through other channels (SMS, automated phone call, and/or email for example). Such notification may be automatically triggered by the geolocation of the buyer leaving a predefined radius (or other geographical condition) from the property they had previously checked in to. As the buyer leaves the predefined radius (or other geographical condition), the SMS announcing the conclusion of the showing is automatically sent to the seller's mobile device. Such notification may also be triggered by the buyer using a “check out” feature in a display on the application.

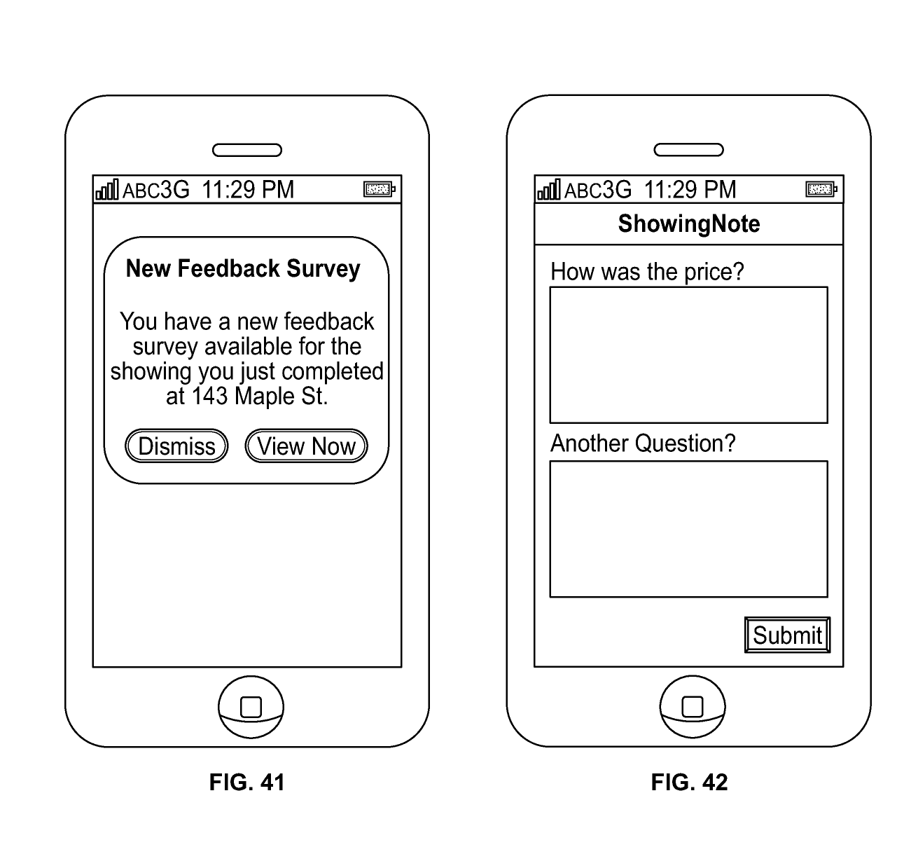

FIG. 41 shows a display that indicates a feedback request. FIG. 42 shows a feedback survey accessed through the “view now” indicator in FIG. 41. A showing feedback request may be sent to the buyer automatically on behalf of the seller once the buyer's mobile device leaves a predefined radius (or satisfies some other geographical condition) from the shown property. The check in location may be marked by a latitude and longitude using the geolocation feature of the phone or may be pulled in from another source that associates geographic coordinates with an address. The geolocation feature may allow the mobile application to trigger a push notification that automatically appears on the buyer's mobile device. The buyer can choose to ignore the feedback request or to fill out a feedback survey. If the buyer chooses to fill out a survey, the mobile application may navigate (or cause a browser on the mobile device to navigate) to a web site (for example, one optimized for a mobile device) to fill out a feedback survey.

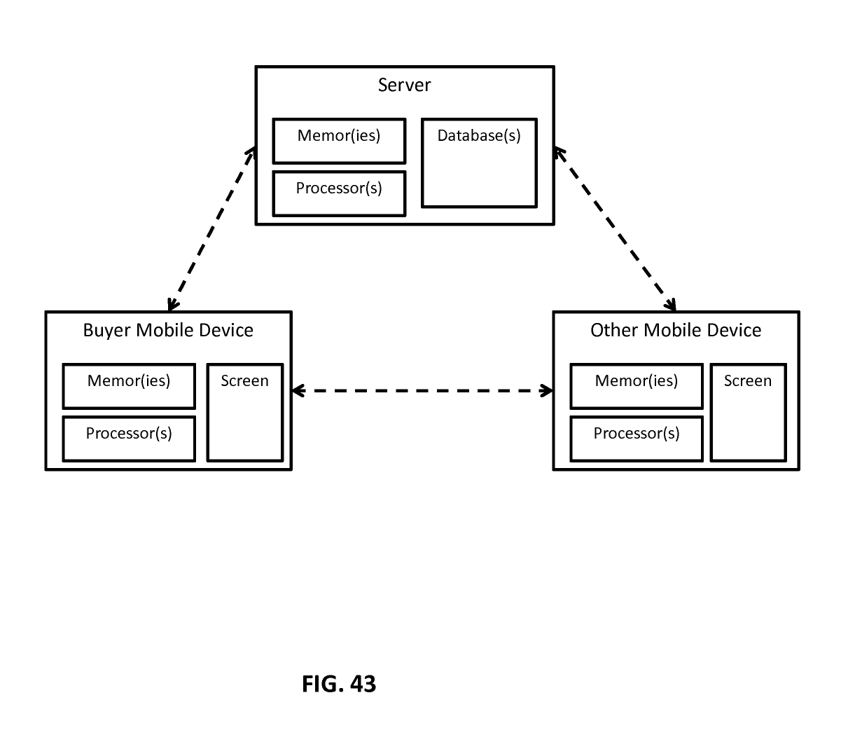

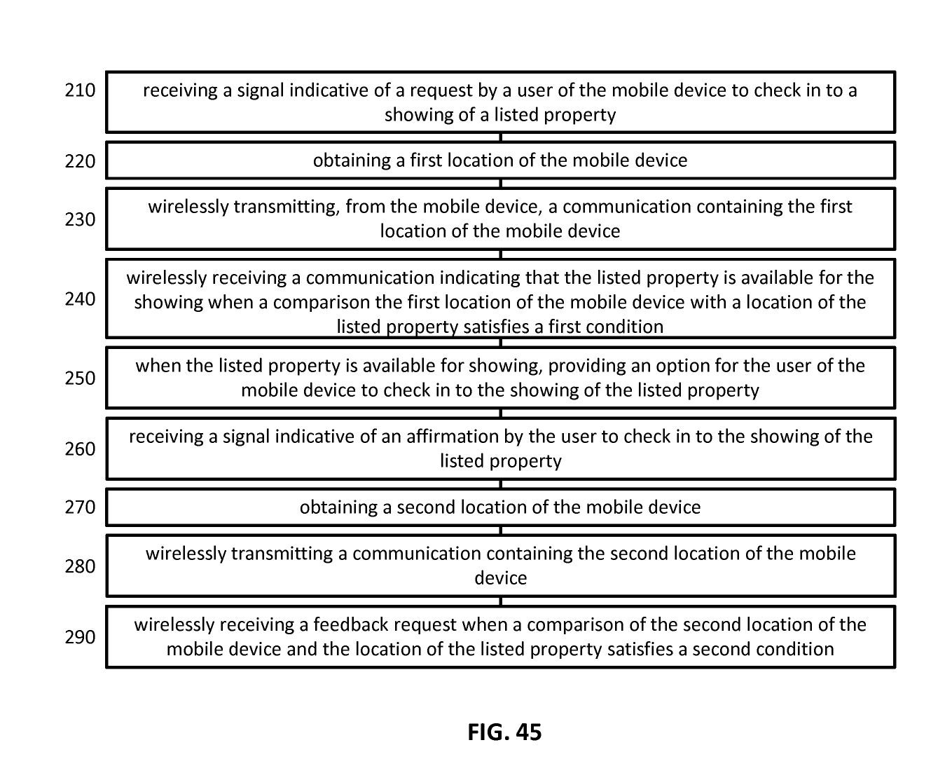

FIG. 43 illustrates a system that may be employed in implementing the inventive techniques disclosed herein. The system may include a server (or a combination of different servers accomplishing the functions attributed to a server discussed herein), a buyer mobile device, and another mobile device. The server may include one or more computer-readable devices (for example, memories). The server may also include one or more processors that, for example, can execute instructions stored on the one or more computer-readable devices. Such execution of instructions may cause steps of a method (such as the one illustrated in FIG. 45) to be performed by the server. The server may include a database that includes information about listed properties. The database may be external to the server. The database may store notebooks, showings, notes, videos, pictures, and all of the other types of information disclosed herein. When needed, the mobile devices may retrieve such information from the server (or another database external to the server). Other non-proprietary databases may be employed for provision of information to the mobile devices, such as an MLS database.

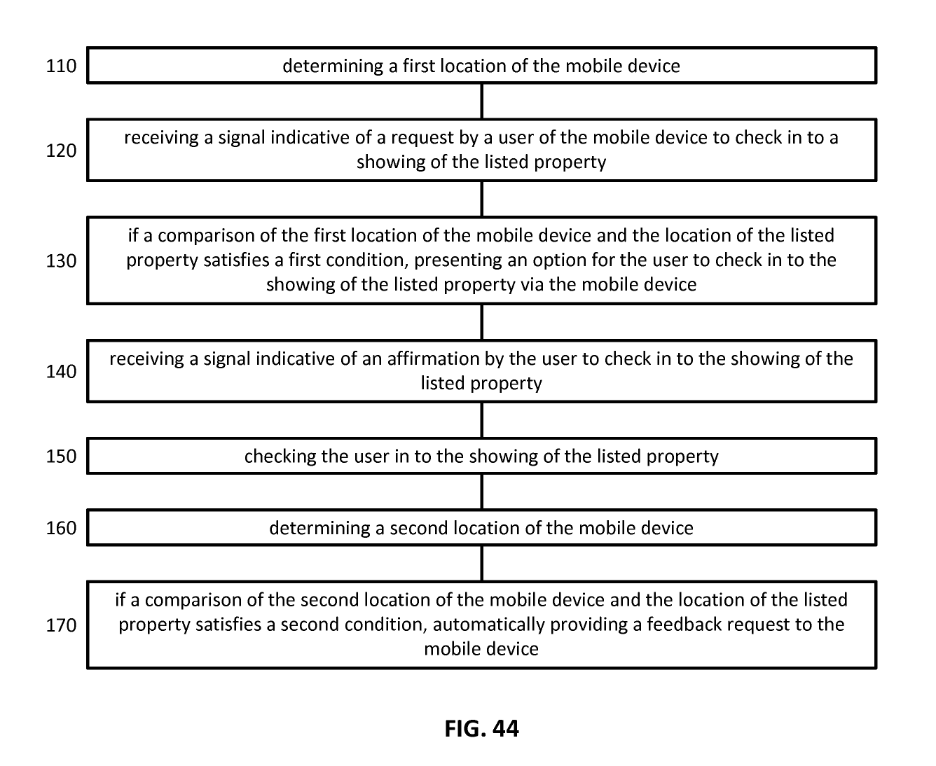

Each mobile device may include one or more computer-readable devices (for example, memories). The mobile device may also include one or more processors that, for example, can execute instructions stored on the one or more computer-readable devices. Such execution of instructions may cause steps of a method (such as the one illustrated in FIG. 44) to be performed by the mobile device. The device may also include a screen. The mobile devices may communicate with each other and with the server (or communicate with each other through the server).

FIG. 44 illustrates a flowchart for performing a method, according to certain inventive techniques. The steps illustrated in the flowchart may be performable at least in part by one or more processors, such as the processor(s) on a mobile device. Furthermore, the steps illustrated in the flowchart may be performable in a different order, or some steps may be omitted according to design and/or preferences. The steps illustrated in the flowchart, or a portion thereof, may be performable by software, hardware, and/or firmware. The steps illustrated in the flowchart, or a portion thereof, may also be expressible through a set of instructions stored on one or more computer-readable storage devices, such as RAM, ROM, EPROM, EEPROM, optical disk, magnetic disk, magnetic tape, and/or the like.

At step 110, a first location of the mobile device may be determined. The first location may be determined based on GPS coordinates (for example, by receiving GPS coordinates from a GPS component in the mobile phone) or by other known geolocation techniques. An application running on the mobile device may receive information relating to the first location, for example, from a GPS component in the mobile device.

At step 120, a signal indicative of a request by a user (for example, the buyer) of the mobile device to check in to a showing of the listed property is received. For example, such a signal may be generated in response to a selection of the “new showing” indication in FIG. 28. The signal may be received by the application running on the mobile device.

At step 130, option may be presented for the user to check in to the showing of the listed property (or one of a plurality of properties) via the mobile device. Such an option may be presented through a display such as the one shown in FIG. 30. This option may only be available if a comparison of the first location of the mobile device and the location of the listed property satisfies a first condition. Such a comparison may be performed by the mobile device or by the server. The first condition may be satisfied if the first location of the mobile device and the location of the listed property are in the same zip code. The first condition may be satisfied if the first location of the mobile device and the location of the listed property are within a predefined distance (for example, one mile) from each other.

At step 140, a signal indicative of an affirmation by the user to check in to the showing of the listed property may be received, for example, by the application. Such a signal may be generated through selection of a property option, such as selection of a desired property listed in FIG. 30.

At step 150, the user may be checked in to the showing of the listed property. By checking in, the showing may be initiated. A communication to that effect may be transmitted (either by the user's mobile device or by the server) to another mobile device (for example, the seller's mobile device). By “checking in,” it should be understood that this can include an initiation of the process of checking in. For example, the user's mobile device can “check in” the user to the showing of the property by communicating a “check in” communication with the server. The server may then take note that the user has checked in, and the server may notify another mobile device (for example, the seller's mobile device) that the showing has begun. Checking in may also be performed by the server.

At step 160, after checking the user in to the showing of the listed property, a second location of the user's mobile device may be determined. The second location may be determined based on GPS coordinates (for example, by receiving GPS coordinates from a GPS component in the mobile phone) or by other known geolocation techniques. An application running on the mobile device may receive information relating to the second location, for example, from a GPS component in the mobile device.

At step 170, if a comparison of the second location of the mobile device and the location of the listed property satisfies a second condition, a feedback request (for example, a push notification) may be automatically provided to the mobile device (for example, from the server). Such a comparison may be performed by the mobile device or by the server. The second condition may be satisfied if the second location of the mobile device and the location of the listed property are not in the same zip code. The second condition may be satisfied if the second location of the mobile device and the location of the listed property are not within a predefined distance (for example, 1000 feet) from each other. An exemplary feedback request and survey are illustrated in FIGS. 41 and 42.

If the second condition is satisfied, the user may be automatically checked out from the showing. By checking out, the showing may end. A communication to that effect may be transmitted (either by the user's mobile device or by the server) to another mobile device (for example, the seller's mobile device). By “checking out,” it should be understood that this can include an initiation of the process of checking out. For example, the user's mobile device can “check out” the user to the showing of the property by communicating a “check out” communication with the server. The server may then take note that the user has checked out, and the server may notify another mobile device (for example, the seller's mobile device) that the showing has ended. Checking out may also be performed by the server.

FIG. 45 illustrates a flowchart for performing a method, according to certain inventive techniques. The steps illustrated in the flowchart may be performable at least in part by one or more processors, such as the processor(s) on a buyer's mobile device. Furthermore, the steps illustrated in the flowchart may be performable in a different order, or some steps may be omitted according to design and/or preferences. The steps illustrated in the flowchart, or a portion thereof, may be performable by software, hardware, and/or firmware. The steps illustrated in the flowchart, or a portion thereof, may also be expressible through a set of instructions stored on one or more computer-readable storage devices, such as RAM, ROM, EPROM, EEPROM, optical disk, magnetic disk, magnetic tape, and/or the like.

At step 210, a signal indicative of a request by a user of the mobile device to check in to a showing of a listed property may be received. For example, such a signal may be generated in response to a selection of the “new showing” indication in FIG. 28. The signal may be received by the application running on the mobile device.

At step 220, a first location of the mobile device may be obtained. The first location may be obtained before step 210 or in response to step 210. The first location may be determined based on GPS coordinates (for example, by receiving GPS coordinates from a GPS component in the mobile phone) or by other known geolocation techniques. An application running on the mobile device may receive information relating to the first location, for example, from a GPS component in the mobile device. At step 230, the mobile device may transmit (for example, to the server) a communication containing the first location of the mobile device.

At step 240, a communication indicating that the listed property is available for the showing when a comparison the first location of the mobile device with a location of the listed property satisfies a first condition may be wirelessly received (for example, from the server). Determination of satisfaction of the first condition may be performed by the server or the mobile device. Such a comparison may be performed by the mobile device or by the server. The first condition may be satisfied if the first location of the mobile device and the location of the listed property are in the same zip code. The first condition may be satisfied if the first location of the mobile device and the location of the listed property are within a predefined distance (for example, one mile) from each other.

At step 250, when the listed property is available for showing, an option for the user of the mobile device to check in to the showing of the listed property may be provided. Such an option may be presented through a display such as the one shown in FIG. 30. This option may only be available if a comparison of the first location of the mobile device and the location of the listed property satisfies the first condition.

At step 260, a signal indicative of an affirmation by the user to check in to the showing of the listed property may be received (for example, by the application). Such a signal may be generated through selection of a property option, such as selection of a desired property listed in FIG. 30.

At step 270, after checking the user in to the showing of the listed property, a second location of the user's mobile device may be determined. The second location may be determined based on GPS coordinates (for example, by receiving GPS coordinates from a GPS component in the mobile phone) or by other known geolocation techniques. An application running on the mobile device may receive information relating to the second location, for example, from a GPS component in the mobile device.

At step 280, a communication containing the second location of the mobile device may be wirelessly transmitted, for example, to the server. At step 290, a feedback request (for example, a push notification) may be wirelessly received (for example, from the server) when a comparison of the second location of the mobile device and the location of the listed property satisfies a second condition. Determination of satisfaction of the second condition may be performed by the server or the mobile device. Such a comparison may be performed by the mobile device or by the server. The second condition may be satisfied if the second location of the mobile device and the location of the listed property are in the same zip code. The second condition may be satisfied if the second location of the mobile device and the location of the listed property are within a predefined distance (for example, one mile) from each other. An exemplary feedback request and survey are illustrated in FIGS. 41 and 42.

If the second condition is satisfied, the user may be automatically checked out from the showing. By checking out, the showing may end. A communication to that effect may be transmitted (either by the user's mobile device or by the server) to another mobile device (for example, the seller's mobile device). By “checking out,” it should be understood that this can include an initiation of the process of checking out. For example, the user's mobile device can “check out” the user to the showing of the property by communicating a “check out” communication with the server. The server may then take note that the user has checked out, and the server may notify another mobile device (for example, the seller's mobile device) that the showing has ended. Checking out may also be performed by the server (for example, when the second condition is satisfied), and a communication that indicates checking out is wirelessly received by the buyer's mobile device.

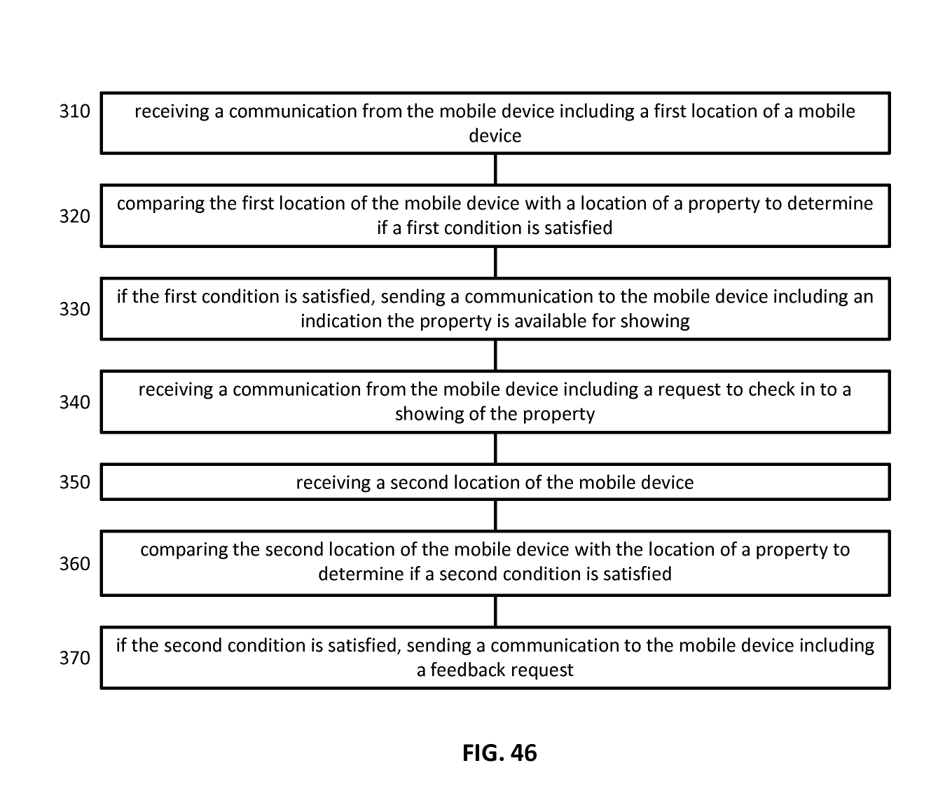

FIG. 46 illustrates a flowchart for performing a method, according to certain inventive techniques. The steps illustrated in the flowchart may be performable at least in part by one or more processors, such as the processor(s) on one or more servers. Furthermore, the steps illustrated in the flowchart may be performable in a different order, or some steps may be omitted according to design and/or preferences. The steps illustrated in the flowchart, or a portion thereof, may be performable by software, hardware, and/or firmware. The steps illustrated in the flowchart, or a portion thereof, may also be expressible through a set of instructions stored on one or more computer-readable storage devices, such as RAM, ROM, EPROM, EEPROM, optical disk, magnetic disk, magnetic tape, and/or the like.

At step 310, communication from the mobile device including a first location of a mobile device may be received. The first location may include GPS-derived coordinates. At step 320, the first location of the mobile device may be compared with a location of a property to determine if a first condition is satisfied. The first condition may be satisfied if the first location of the mobile device and the location of the listed property are in the same zip code. The first condition may be satisfied if the first location of the mobile device and the location of the listed property are within a predefined distance (for example, one mile) from each other.

At step 330, if the first condition is satisfied, a communication may be sent to the mobile device including an indication the property is available for showing. At step 340, a communication from the mobile device including a request to check in to a showing of the property may be received. Checking in may then proceed in a manner similar to that discussed above.

At step 350, after checking in, a communication from the mobile device including a second location of a mobile device may be received. At step 360, the second location of the mobile device with the location of a property may be compared to determine if a second condition is satisfied. The second condition may be satisfied if the second location of the mobile device and the location of the listed property are in the same zip code. The second condition may be satisfied if the second location of the mobile device and the location of the listed property are within a predefined distance (for example, one mile) from each other. At step 370, if the second condition is satisfied, a communication may be sent to the mobile device including a feedback request (for example, push notification). An exemplary feedback request and survey are illustrated in FIGS. 41 and 42.

If the second condition is satisfied, a communication may be sent to the mobile device indicating checking out of the showing. By checking out, the showing may end. A communication to that effect may be transmitted (either by the user's mobile device or by the server) to another mobile device (for example, the seller's mobile device).

Aspects of the techniques described herein may be implemented in digital electronic circuitry, computer software, firmware, or hardware, including the structures disclosed herein and their structural equivalents, or in various combinations. Aspects of the techniques described herein may be implemented as one or more computer programs, for example, one or more sets of program instructions residing on or encoded in a computer-readable storage medium for execution by, or to control the operation of, one or more processors. Alternatively or in addition, the instructions may be encoded on an artificially-generated propagated signal, for example, a machine-generated electrical, optical, or electromagnetic signal that may be generated to encode information for transmission to a suitable receiver apparatus for execution by one or more processors. A computer-readable medium may be, or be included in, a computer-readable storage device, a computer-readable storage substrate, a random or serial access memory array or device, various combinations thereof. Moreover, while a computer-readable medium may or may not be a propagated signal, a computer-readable medium may be a source or destination of program instructions encoded in an artificially-generated propagated signal. The computer-readable medium may also be, or be included in, one or more separate physical components or media (for example, CDs, disks, or other storage devices).

Certain techniques described in this specification may be implemented as operations performed by one or more processors on data stored on one or more computer-readable mediums or received from other sources. The term “processor” may encompass various kinds of apparatuses, devices, or machines for processing data, including by way of example a central processing unit, a microprocessor, a microcontroller, a digital-signal processor, programmable processor, a computer, a system on a chip, or various combinations thereof. The processor may include special purpose logic circuitry, for example, a field programmable gate array or an application-specific integrated circuit.

Program instructions (for example, a program, software, software application, script, or code) may be written in various programming languages, including compiled or interpreted languages, declarative or procedural languages, and may be deployed in various forms, for example as a stand-alone program or as a module, component, subroutine, object, or other unit suitable for use in a computing environment. Program instructions may correspond to a file in a file system. Program instructions may be stored in a portion of a file that holds other programs or data (for example, one or more scripts stored in a markup language document), in a dedicated file or in multiple coordinated files (for example, files that store one or more modules, sub-programs, or portions of code). Program instructions may be deployed to be executed on one or more processors located at one site or distributed across multiple sites connected by a network.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A method for facilitating communication regarding a listed property using a mobile device running an application, wherein the mobile device is in communication with at least one server, and wherein the method comprises:
determining a first location of the mobile device;
receiving, by the application from the mobile device, a signal indicative of a request by a user of the mobile device to check in to a showing of the listed property;
if a comparison of the first location of the mobile device and the location of the listed property satisfies a first condition, presenting an option for the user to check in to the showing of the listed property via the mobile device;
receiving, by the application from the mobile device, a signal indicative of an affirmation by the user to check in to the showing of the listed property;
in response to receiving the signal indicative of an affirmation by the user to check in to the showing of the listed property, checking the user in to the showing of the listed property;
after checking the user in to the showing of the listed property, determining a second location of the mobile device;
if a comparison of the second location of the mobile device and the location of the listed property satisfies a second condition, automatically providing a feedback request to the mobile device.

2. The method of claim 1, further comprising:
if the comparison of the second location of the mobile device and the location of the listed property satisfies the second condition, automatically checking the user out of the showing of the listed property.

3. The method of claim 2, further comprising:
sending a communication to the mobile device indicating that the showing of the listed property has ended.

4. The method of claim 1, wherein the first condition is satisfied when the first location of the mobile phone and the location of the listed property are in the same zip code.

5. The method of claim 4, wherein the second condition is satisfied when a distance between the second location of the mobile device and the location of the listed property is greater than a predetermined distance.

6. The method of claim 1, wherein the second condition is satisfied when a distance between the second location of the mobile device and the location of the listed property is greater than a predetermined distance.

7. The method of claim 1, wherein the feedback request comprises a push notification on the mobile device.

8. At least one computer-readable device including instructions for execution by at least one processor on a mobile device, wherein when the instructions are executed, the instructions cause the mobile device to perform operations including:
receiving a signal indicative of a request by a user of the mobile device to check in to a showing of a listed property;
obtaining a first location of the mobile device;
wirelessly transmitting, from the mobile device, a communication containing the first location of the mobile device;
wirelessly receiving a communication indicating that the listed property is available for the showing when a comparison the first location of the mobile device with a location of the listed property satisfies a first condition;
when the listed property is available for showing, providing an option for the user of the mobile device to check in to the showing of the listed property;
receiving a signal indicative of an affirmation by the user to check in to the showing of the listed property;
after receiving a signal indicative of an affirmation by the user to check in to the showing of the listed property, obtaining a second location of the mobile device;
wirelessly transmitting a communication containing the second location of the mobile device;
wirelessly receiving a feedback request when a comparison of the second location of the mobile device and the location of the listed property satisfies a second condition.

9. The at least one computer-readable device of claim 8, wherein when the instructions are executed, the instructions cause the mobile device to perform operations further including:
wirelessly receiving a communication that indicates checking out of the showing when the comparison of the second location of the mobile device and the location of the listed property satisfies the second condition.

10. The at least one computer-readable device of claim 8, wherein the first condition is satisfied when the first location of the mobile phone and the location of the listed property are in the same zip code.

11. The at least one computer-readable device of claim 10, wherein the second condition is satisfied when a distance between the second location of the mobile device and the location of the listed property is greater than a predetermined distance.

12. The at least one computer-readable device of claim 8, the second condition is satisfied when a distance between the second location of the mobile device and the location of the listed property is greater than a predetermined distance.

13. The at least one computer-readable device of claim 8, wherein the feedback request comprises a push notification.

14. A method for facilitating communication regarding a listed property using a server, wherein the server is in communication with at least one mobile device, and wherein the method comprises:
receiving a communication from the mobile device including a first location of a mobile device;
comparing the first location of the mobile device with a location of a property to determine if a first condition is satisfied;
if the first condition is satisfied, sending a communication to the mobile device including an indication the property is available for showing;
receiving a communication from the mobile device including a request to check in to a showing of the property;
subsequent to said receiving a communication from the mobile device including a request to check in to a showing of the property, receiving a communication from the mobile device including a second location of a mobile device;
comparing the second location of the mobile device with the location of a property to determine if a second condition is satisfied;
if the second condition is satisfied, sending a communication to the mobile device including a feedback request.

15. The method of claim 14, further comprising:
sending a communication to the mobile device indicating checking out of the showing when the comparison of the second location of the mobile device and the location of the listed property satisfies the second condition.

16. The method of claim 14, wherein the first condition is satisfied when the first location of the mobile phone and the location of the listed property are in the same zip code.

17. The method of claim 16, wherein the second condition is satisfied when a distance between the second location of the mobile device and the location of the listed property is greater than a predetermined distance.

18. The method of claim 14, wherein the second condition is satisfied when a distance between the second location of the mobile device and the location of the listed property is greater than a predetermined distance.

19. The method of claim 14, wherein the feedback request comprises a push notification.
